(19) United States
(12) Patent Application Publication
(10) Pub. No.: US 2025/0036772 A1
(43) Pub. Date: Jan. 30, 2025

(54) SECURING DATA PROCESSING SYSTEMS BASED ON EXPRESSED VULNERABILITIES

(71) Applicant: Dell Products L.P., Round Rock, TX (US)

(72) Inventors: MAXIM BALIN, Gan-Yavne (IL); TOMER SHACHAR, Beer-Sheva (IL); YEVGENI GEHTMAN, Modi'in (IL)

(21) Appl. No.: 18/359,448

(22) Filed: Jul. 26, 2023

(51) Int. Cl. G06F 21/57

(52) U.S. Cl. CPC G06F 21/577

(57) ABSTRACT

Methods, systems, and devices for providing computer implemented services are disclosed. To provide the computer implemented services, an identification of a vulnerability of a component of the data processing system may be made. The vulnerability may render a data processing system exploitable by a malicious entity if the vulnerability is expressed by the data processing system. A determination regarding whether the data processing system expressed the vulnerability may be made. If the vulnerability is expressed, then an action set to mitigate a potential impact of the expressed vulnerability may be performed.

### FIELD

Embodiments disclosed herein relate generally to device management. More particularly, embodiments disclosed herein relate to systems and methods for managing security of a data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a data flow diagram illustrating security management of a data processing system in accordance with an embodiment.

FIG. 2B shows a data flow diagram illustrating population of a repository in accordance with an embodiment.

FIGS. 2C-2E show data structure diagrams illustrating representations of a repository in accordance with an embodiment.

FIG. 3 shows a flow diagram illustrating a method for managing security of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing, at least in part, computer implemented services. To provide the services, a system may include any number of software components and/or hardware components (e.g., processors, memory modules, application programs, device drivers, etc.). These software components and/or hardware components may perform operations that cause the data processing system to provide the computer implemented services.

However, some operations, when performed under certain conditions, may render the data processing system vulnerable to compromise. If the certain conditions are met, the data processing system may be made exploitable by a malicious entity due to a vulnerability being expressed by the data processing system. Consequently, if the expressed vulnerability is exploited, the computer implemented services provided by the data processing system may be compromised.

To efficiently manage security of data processing systems, a system in accordance with an embodiment may mitigate an impact of a possible exploitation of a vulnerability based on whether the vulnerability is expressed by the data processing system.

To do so, the system may proactively identify whether vulnerabilities are expressed by data processing systems prior to dedicating resources to determining whether the vulnerabilities have been exploited. By limiting dedication of resources to only those systems that have been identified as likely having expressed vulnerabilities, a resource cost for identifying data processing systems that have been exploited may be reduced.

In an embodiment, a method is provided for managing security of a data processing system.

The method may include making an identification of a vulnerability of a component of the data processing system, the vulnerability rendering the data processing system exploitable by a malicious entity if the vulnerability is expressed by the data processing system; making a determination regarding whether the data processing system expressed the vulnerability, the determination being made using a record of changes in the operation of the components of the data processing system over time and requirements for the vulnerability to be expressed; in a first instance of the determination where the vulnerability is expressed by the data processing system: performing an action set to mitigate a potential impact of the expressed vulnerability; and in a second instance of the determination where the vulnerability is not expressed by the data processing system: confirming to a requestor that the data processing system did not express the vulnerability.

Making the determination may include identifying, based on the requirements for the vulnerability, an operation of the component; making a second determination, based on the record, whether the component performed the operation; in a first instance of the second determination where the component performed the operation: concluding that the vulnerability was expressed by the data processing system; and in a second instance of the second determination where the component did not perform the operation: concluding that the vulnerability was not expressed by the data processing system.

Making the determination may further include, in the first instance of the second determination: identifying a duration of time while the vulnerability was expressed by the data processing system using the record.

The method may further include monitoring the changes to the operation of the components; and recording the changes in an immutable record to obtain the record.

Monitoring the changes may include identifying updates made to software components of the components.

Monitoring the changes may further include identifying durations of time during which each updated software component of the software components was hosted by the data processing system.

Each updated software component is a version of the software component.

The requirements for the vulnerability to be expressed may include a version of the software component to be hosted by the data processing system.

Performing the action set may include making a second determination regarding whether a malicious entity exploited the expressed vulnerability; in an instance of the second determination in which the malicious entity exploited the expressed vulnerability: performing a second action set to mitigate an impact of the exploitation of the expressed vulnerability.

In an embodiment, a non-transitory media is provided that may include instructions that when executed by a processor cause the computer-implemented method to be performed.

In an embodiment, a data processing system is provided that may include the non-transitory media and a processor and may perform the computer-implemented method when the computer instructions are executed by the processor.

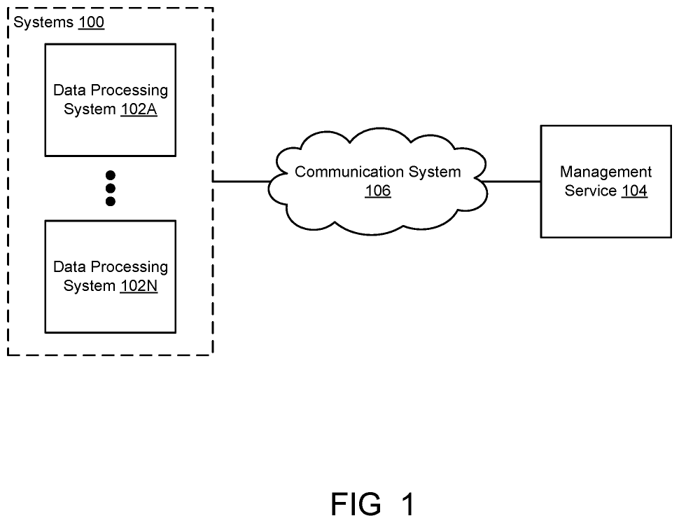

Turning to FIG. 1, a block diagram illustrating a system in accordance with an embodiment is shown. The system shown in FIG. 1 may provide computer implemented services. The computer implemented services may include any type and/or quantity of computer implemented services. For example, the computer implemented services may include data storage services, instant messaging services, database services, and/or any other type of service that may be implemented with a computing device.

To provide the computer implemented services, the data processing system may include software and/or hardware components (e.g., processors, memory modules, application programs, device drivers, etc.). These components may perform operations for the data processing system. By performing the operations, the components may cause the data processing system to provide the computer implemented services.

However, one or more of the components may, under certain conditions, perform an operation that renders the data processing system vulnerable to compromise. When the conditions are met by the data processing system, the data processing system may be made exploitable by a malicious entity due to the vulnerability being expressed by the data processing system. Consequently, if the expressed vulnerability is exploited, the computer implemented services provided by the data processing system may be compromised. For example, the compromise may result in malicious entities gaining access to otherwise restricted data, the data processing system performing undesired computer implemented services, etc.

To mitigate an impact of the exploitation, any number of data processing systems that include components capable of performing the operation under the conditions that cause the vulnerability to be expressed may be checked for evidence of the exploitation. However, checking the data processing systems for the evidence of the exploitation may be time-consuming and/or resource intensive thereby directing limited resources for managing security of the data processing systems rather than providing desired computer implemented services.

In general, embodiments disclosed herein may provide methods, systems, and/or devices for efficiently managing security of a data processing system. To efficiently manage security of data processing systems, a system in accordance with an embodiment may proactively identify whether vulnerabilities are expressed by data processing systems prior to dedicating resources to determining whether the vulnerabilities have been exploited. By limiting dedication of resources to only those systems that have been identified as likely having expressed vulnerabilities, a resource cost for identifying data processing systems that have been exploited may be reduced.

To manage security of the data processing system, as vulnerabilities of software and/or hardware components of the data processing system are identified, expression of these vulnerabilities by the data processing systems may be investigated. During the investigations, a determination may be made regarding whether the data processing system has actually expressed the vulnerability at any point in time.

By expressing the vulnerability, the data processing system may meet a requirement for being exploitable using the vulnerability. Therefore, only the data processing system that is determined as having expressed the vulnerability may undergo further scrutiny to identify whether the data processing system has been exploited using the expressed vulnerability.

If the data processing system has not expressed the vulnerability at any point in time, the data processing system may not meet the requirement for being exploitable using the vulnerability. Therefore, the data processing system may not need further scrutiny to identify whether the data processing system has been exploited using the vulnerability because the exploitation would not be possible without the vulnerability being expressed.

To proactively identify whether data processing systems have expressed vulnerabilities, information regarding conditions of hardware and/or software components of data processing system may be recorded over time. When new vulnerabilities are identified, the prerequisite conditions (e.g., conditions of the hardware and/or software components) for expression of the vulnerabilities may be compared to the recorded information to identify whether (and during which periods of time) the new vulnerabilities are expressed by the data processing system.

Thus, exploitation management for data processing systems may be enhanced by only checking for evidence of the exploitation in data processing systems that have expressed the vulnerability rather than any data processing system that includes components capable of performing an operation responsible for the vulnerability regardless of whether the prerequisite conditions for expression of the vulnerability were present. For example, checking only the data processing systems that have expressed the vulnerability may be less time-consuming than checking all data processing systems that include components subject to the vulnerability.

To provide the above noted functionality, the system of FIG. 1 may include systems 100, management service 104, and communication system 106. Each of these components is discussed below.

Systems 100 may include any number of data processing systems (e.g., 102A-102N). These data processing systems may provide computer implemented services. To provide the computer implemented services, a data processing system (e.g., 102A) of systems 100 may include software and/or hardware components. For example, data processing system 102A may provide computer implemented services using software and/or hardware components (e.g., processors, memory modules, application programs, device drivers, etc.) that may be capable of performing operations. By performing the operations, the components may facilitate the provision of the computer implemented services by data processing system 102A.

However, these components of data processing system 102A (and/or of any other data processing systems of systems 100) may perform an operation that may be exploited to compromise the data processing system when certain conditions are present (e.g., expressing a vulnerability), as previously discussed. By presenting the vulnerability, data processing system 102A may be made exploitable by a malicious entity if the vulnerability is expressed by the data processing system. If exploited, the vulnerability may delay and/or prevent the computer implemented services entirely.

To mitigate an impact of the exploitation on data processing systems 102A-102N, management service 104 may manage systems 100. Management service 104 may (i) identify a vulnerability (e.g., the vulnerability mentioned above) of a software and/or hardware component of, for example, data processing system 102A, (ii) determine (based on the identification) whether the vulnerability has been previously (and/or is currently) expressed by, for example, data processing system 102A, and/or (iii) facilitate further scrutiny of, for example, data processing system 102A (if the vulnerability has been expressed) to identify whether data processing system 102A has been exploited using the expressed vulnerability to compromise the system.

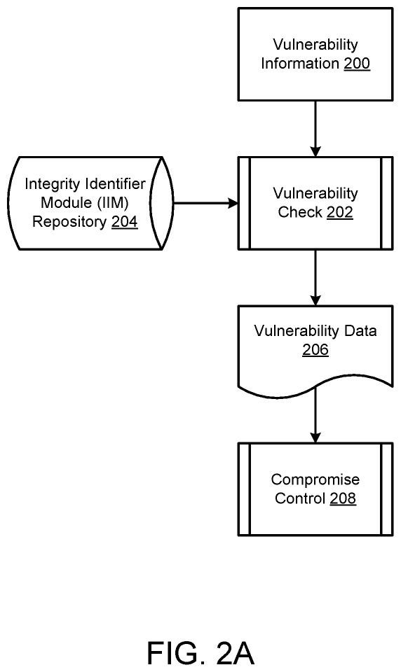

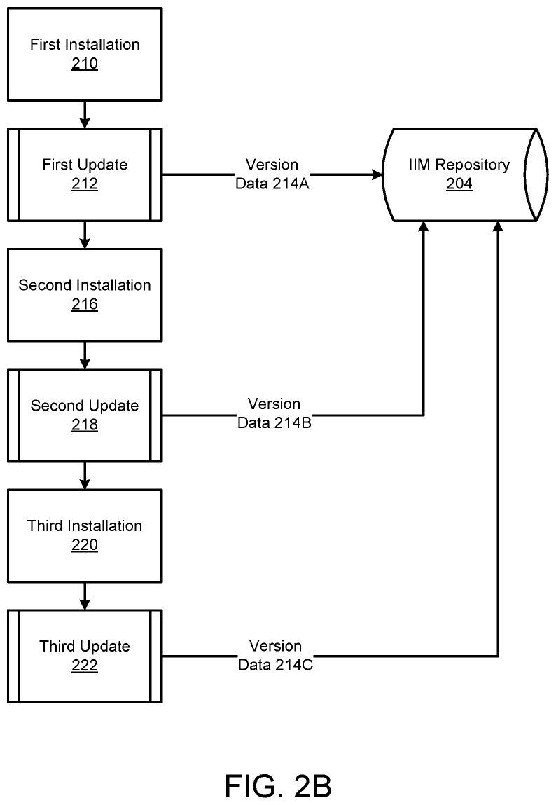

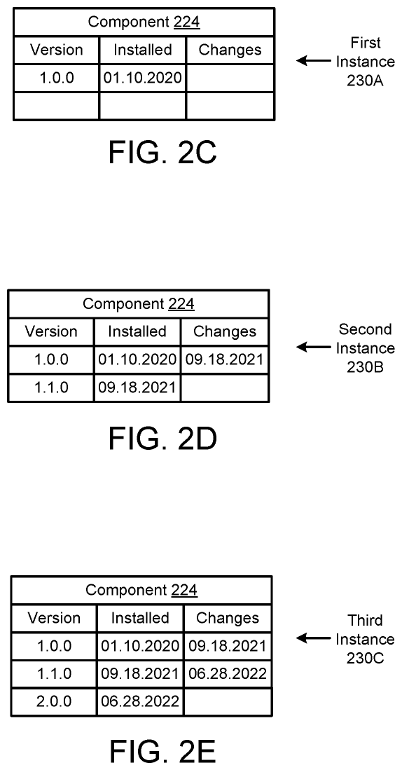

Refer to FIG. 2A-2B for additional details regarding mitigation of an impact of an exploitation of vulnerabilities.

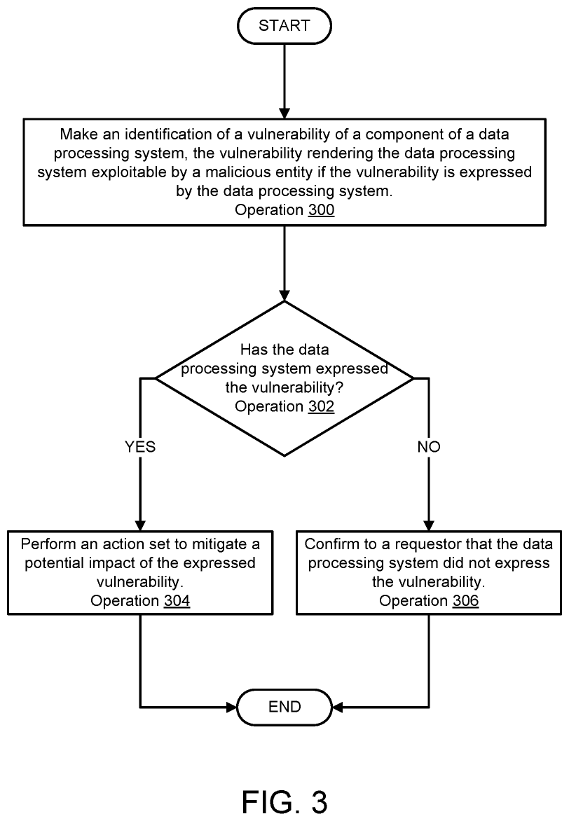

When performing their functionality, systems 100 and/or management service 104 may perform all, or a portion, of the methods and/or actions described in FIGS. 2A-3.

Systems 100 and/or management service 104 may be implemented using one or more computing devices such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

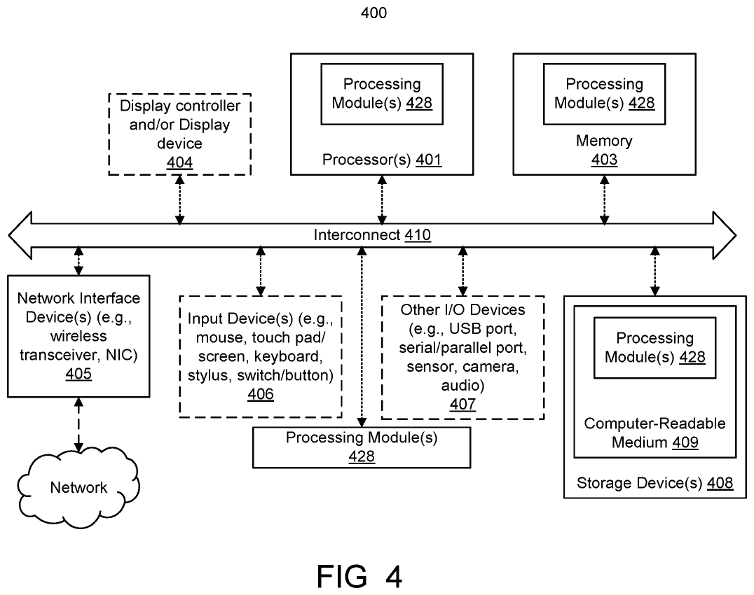

Refer to FIG. 4 for additional details regarding computing devices.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein. For example, while illustrated as being separate, the functionalities of any of the components shown in FIG. 1 may be performed via a single device or divided among any number of devices.

To further clarify embodiments disclosed herein, data flow diagrams in accordance with an embodiment are shown in FIGS. 2A-2B. These data flow diagrams may illustrate how data is obtained and used within the system of FIG. 1.

Turning to FIG. 2A, a first data flow diagram in accordance with an embodiment is shown. The first data flow diagram may illustrate data structures used in and/or processes performed during mitigation of an impact of an exploitation of a vulnerability expressed by a data processing system (e.g., 102A). For example, and as previously discussed, data processing system 102A may include software and/or hardware components that perform operations to provide computer implemented services. The computer implemented services may be compromised (e.g., delayed and/or prevented entirely) if a vulnerability provided by one of the operations is (i) expressed by data processing system 102A, and (ii) exploited.

To ascertain whether a data processing system has been exploited, vulnerability information 200 may be obtained. Vulnerability information 200 may include information regarding a vulnerability of a software component and/or hardware component. Vulnerability information may be obtained by receiving it from another device (e.g., a device operated by a research group that may actively investigate and distribute information regarding vulnerabilities), generating it based on an investigation or other process of analysis, and/or via other processes.

Vulnerability information 200 may include information regarding the vulnerability including, for example, the nature of the vulnerability, prerequisite conditions for the vulnerability to be met, impacts of the vulnerability, etc.

Vulnerability information 200 may be obtained, for example, based on a request obtained from a client of management service 104. For example, the client may be aware of a specific vulnerability caused by the operation and may request for management service 104 to initiate a security process based on the specific vulnerability. Vulnerability information 200 may be obtained based on this request.

Once obtained, vulnerability information 200 may be ingested by vulnerability check 202 to ascertain whether various data processing systems have expressed the vulnerability.

During vulnerability check 202, a determination may be made regarding whether the vulnerability has previously been, and/or is currently being, expressed by data processing system 102A (and/or other data processing systems). To make the determination, a comparison may be made between the prerequisite conditions specified by vulnerability information 200 and conditions of data processing system 102 as specified by integrity identifier module (IIM) repository 204 (discussed further below) to ascertain whether data processing system 102A exhibited the prerequisite conditions. Refer to FIG. 2B for additional details regarding IIM repository 204.

If the prerequisite conditions are found in IIM repository 204, then it may be determined that the vulnerability has been, and/or is currently, expressed by data processing system 102A. If the prerequisite conditions are not found, then it may be determined that the vulnerability has not been, and is currently not being, expressed by data processing system 102A.

If it is determined that the vulnerability is not and has not been expressed, then a notification may be sent to the client and/or otherwise communicated with data processing system 102A that there is no risk of compromise based on the vulnerability.

If determined that the vulnerability has been (and/or is currently) expressed by data processing system 102A, data regarding the vulnerability's expression (e.g., vulnerability data 206) may be obtained from IIM repository 204, discussed below.

To time efficiently ascertain whether a vulnerability has been expressed, IIM repository 204 may include information regarding conditions present in data processing system 102A over time. For example, IIM repository 204 may include a history (e.g., a list) of: (i) hardware/software components present in data processing system 102A over time, (ii) versions of the hardware/software components over time, (iii) configurations of the hardware/software components over time, (iv) operations performed by the components over time, and/or other information usable to diagnose whether a vulnerability was/is expressed by data processing system 102A.

Refer to FIG. 2B for additional details regarding an IIM repository (e.g., 204).

Vulnerability data 206 may include information regarding vulnerabilities expressed by data processing system 102A. The information may include, for example, (i) identifiers of expressed vulnerabilities, (ii) the prerequisites for the vulnerabilities and/or how the prerequisites were met, (iii) a time frame in which the vulnerabilities were expressed, and/or (iv) other data regarding the expressed vulnerability.

Vulnerability data 206 may be ingested by compromise control 208 to manage impacts of the expressed vulnerability. During compromise control 208, any number of diagnostic processes may be performed on data processing system 102A to ascertain whether the expressed vulnerability was exploited. The diagnostic processes may include searching, (based on the expressed vulnerabilities) for various types of malicious entities (e.g., malware, viruses, etc.), artifacts or other indicators of previous presence of malicious entities, etc.

In a scenario in which data processing system 102A is managed by a separate entity from that which performs vulnerability check 202, vulnerability data 206 may be provided to the other entity. By providing the information from vulnerability data 206, the entity that manages data processing system 102A may be capable of making an informed decision regarding what actions to take (e.g., try to identify malicious entities present on data processing system 102) in mitigating a possible impact from exploitation of the vulnerability.

For example, knowing the time frame in which the vulnerability was expressed may indicate specific information (e.g., passwords, emails, credit card numbers, social security numbers, bank account numbers, etc.) at risk of compromise due to possible exploitation of the vulnerability. Thus, security regarding the specific information may be modified to mitigate impact of the possible exploitation.

Also, during compromise control 208, searches of a wide variety of websites for instances of the specific information at risk of compromise may be performed (e.g., which may indicate that a compromise has previously occurred).

If relevant information is identified as being present, various services for and information may be provided to an impacted user such as (i) changing passwords, (ii) freezing credit, (iii) searching through databases for compromised information, (iv) monitoring of accounts for suspicious activity, (v) scrubbing the information from the websites, and/or (vi) other actions that may reduce impacts of compromises of data processing system 102A.

Thus, by using the security process shown in FIG. 2A, an impact of an exploitation of a vulnerability expressed by a data processing system (e.g., 102A) may be mitigated.

As discussed above, the content of an IIM repository (e.g., 204) may be used to determine whether vulnerabilities are expressed by a data processing system (e.g., 102A). To populate the content of the IIM repository, information regarding changes to hardware components and/or software components of the data processing system may be monitored over time and recorded.

Turning to FIG. 2B, a second data flow diagram in accordance with an embodiment is shown. The second data flow diagram may illustrate data structures used in and/or processes performed during population of an IIM repository (e.g., 204).

To populate the IIM repository, changes to hardware components and/or software components of a data processing system (e.g., 102A) may be monitored and recorded over time. In FIG. 2B, an example set of changes (e.g., 210-222) are shown and used to describe how the IIM repository is populated.

For example, assume a software component (e.g., a device driver) is installed (e.g., configured for use) onto a data processing system (e.g., 102A) and updated (e.g., changed) over time. The instillation may begin at first installation 210, during which a first version of the device driver may be installed. Once installed, the first version may determine a first operation of the device driver. For example, the first operation may facilitate communication between an operating system of data processing system 102A and a hardware component (e.g., a graphics processing unit (GPU)) of data processing system 102A in a specific manner.

Based on first installation 210, first update 212 may be performed. First update 212 may include obtaining information about first installation 210 (e.g., version data 214A), and populating IIM repository 204 with the information. Version data 214A may include (i) information used to differentiate the first version from other versions of the device driver (e.g., a version title), (ii) a time and/or date in which first installation 210 was performed, and/or (iii) other information regarding the first version of the device driver.

For a first example instance of IIM repository 204 that reflects first update 212, refer to FIG. 2C.

Now assume that an amount of time has passed (e.g., a year) since first instillation 210 was performed, and a second version of the device driver has become available (e.g., a developer of the device driver has publicly released a new version that determines a new operation of the device driver). The second version may determine a second operation of the device driver that facilitates the communication between the operating system and the hardware component in a manner that is different to the first operation.

To update (e.g., change) operation of the device driver from the first operation to the second operation, second installation 216 may be performed. During second installation 216, the second version of the device driver may be installed, thus updating operation of the device driver to the second operation.

In some cases, second installation 216 may result in at least a portion of data (e.g., digital files) associated with the first version being modified or deleted entirely from storage of data processing system 102A. However, version data 214A recorded in IIM repository 204 may remain unchanged.

Based on second installation 216, second update 218 may be performed. Second update 218 may include obtaining information about second installation 216 (e.g., version data 214B), and populating IIM repository 204 with the information. Similar to version data 214A, version data 214B may include (i) information used to differentiate the second version from the other versions (e.g., the first version), (ii) a time and/or date in which second installation 216 was performed, and/or (iii) other information regarding the second version of the driver.

Additionally, a time and/or date in which the first version was modified (to allow for update to the second operation) may be recorded in IIM repository 204. Doing so may result in IIM repository 204 indicating a time frame of when the first version began being expressed by data processing system 102A to when the first version stopped being expressed by data processing system 102A.

For a second example instance of IIM repository 204 that reflects second update 216, refer to FIG. 2D.

As new versions become available, installation of such versions may proceed as described above for any number of software and/or hardware components of data processing system 102A any number of times. For example, assume that another amount of time has passed (e.g., another year) since second instillation 216 was performed, and a third version of the device driver becomes available. The third version may determine a third operation of the device driver that is different from that of the first version and/or second version.

To update (e.g., change) operation of the device driver from the second operation to the third operation, third instillation 220 may be performed. During third instillation 220, the third version of the device driver may be installed, thus updating operation of the device driver to the third operation.

Similar to second instillation 216, in some cases, third installation 220 may result in at least a portion of data associated with the second version being modified or deleted entirely from storage of data processing system 102A. However, version data 214A-214B recorded in IIM repository 204 may remain unchanged.

Accordingly, as the new versions are installed, information regarding the installations may be recorded in IIM repository 204 as described above for the any number of software and/or hardware components based on the any number of times. For example, based on third installation 220, third update 222 may be performed. Third update 222 may include obtaining information about third installation 220 (e.g., version data 214C), and populating IIM repository 204 with the information.

Additionally, a time and/or date in which the second version was modified (to allow for update to the third operation) may be recorded in IIM repository 204. This modification may result in a second time frame that indicates when the second version began being expressed by data processing system 102A and when the second version stopped being expressed by data processing system 102A.

For a third example instance of IIM repository 204 that reflects third update 222, refer to FIG. 2E.

By populating IIM repository 204 with information regarding changes to software and/or hardware components, IIM repository 204 may be efficiently equipped for ascertaining whether the data processing system has exhibited prerequisite conditions for expressing a vulnerability. Thus, expression of known vulnerabilities may be identified and an impact of exploitation of any of the expressed vulnerabilities may be mitigated.

It will be appreciated that while illustrated and described using a limited number of data structures and processes, the data flow diagrams of FIGS. 2A-2B in accordance with an embodiment may include fewer, additional, and/or different data structures and/or processes than those discussed herein.

To further clarify embodiments disclosed herein, data structure diagrams in accordance with an embodiment are shown in FIGS. 2C-2E. These data structure diagrams may illustrate data structures representative of example instances of information regarding a condition of a software and/or hardware component recorded in an IIM repository (e.g., 204) as discussed with regard to FIG. 2B.

Turning to FIG. 2C, a first data structure diagram in accordance with an embodiment is shown. The first data structure diagram may illustrate a data structure representative of a first example instance of IIM repository 204 that reflects performance of first update 212 as discussed with regard to FIG. 2B.

As shown in FIG. 2C, first instance 230A may include (i) a version title (e.g., 1.0.0) for a first version of a software component (e.g., 224) and (ii) a date (e.g., 01.10.2020) in which the first version begins being expressed by a data processing system hosting component 224.

Turning to FIG. 2D, a second data structure diagram in accordance with an embodiment is shown. The second data structure diagram may illustrate a data structure representative of a second example instance of IIM repository 204 that reflects performance of second update 218 as discussed with regard to FIG. 2B.

As shown in FIG. 2D, second instance 230B may include (i) data from instance 230A, mentioned above, (ii) a version title (e.g., 1.1.0) for a second version of component 224, and (iii) a date (e.g., 09.18.2021) in which the second version begins being expressed by (and in which the first version stops being actively expressed by) the data processing system hosting component 224.

Turning to FIG. 2E, a third data structure diagram in accordance with an embodiment is shown. The third data structure diagram may illustrate a data structure representative of a third example instance of IIM repository 204 that reflects performance of third update 222 as discussed with regard to FIG. 2B.

As shown in FIG. 2E, third instance 230C may include (i) data from instances 230A-230B, mentioned above, (ii) a version title (e.g., 2.0.0) for a third version of component 224, and (iii) a date (e.g., 06.28.2022) in which the third version begins being expressed by (and in which the second version stops being actively expressed by) the data processing system hosting component 224.

It will be appreciated that while illustrated and described as having specific structures and including specific information, the data structure diagrams of FIGS. 2C-2E in accordance with an embodiment may include fewer, additional, and/or different structures and/or information than those discussed herein.

As discussed above, the components (depicted using data structures and data flows) of FIGS. 1-2E may perform (and/or be used to perform) various methods for managing security of a data processing system in a manner that enhances an efficiency of security and/or operation of the data processing system.

To further clarify embodiments disclosed herein, a flow diagram in accordance with an embodiment is shown in FIG. 3. This flow diagram shows a method that may enhance security and/or operation of a data processing system. While described with respect to vulnerabilities of software and/or hardware components hosted by data processing systems, it will be understood that embodiments disclosed herein are broadly applicable to different use cases (e.g., different data management and/or security cases) as well as different types of data processing systems than those described below.

In the flow diagram discussed below, any of the operations may be repeated, performed in different orders, omitted, and/or performed in parallel manner with other operations or a partially overlapping in-time manner with other operations.

Turning to FIG. 3, a flow diagram illustrating a method for managing security of a data processing system in a manner that enhances security and/or operation of the data processing system in accordance with an embodiment is shown. The method may be performed by, for example, a data processing system, a management service, and/or other components illustrated and/or discussed in FIGS. 1-2B.

At operation 300, an identification of a vulnerability of a component of a data processing system is made, the vulnerability rendering the data processing system exploitable by a malicious entity if the vulnerability is expressed by the data processing system. The identification may be made by obtaining information regarding the vulnerability (e.g., the component responsible for providing the vulnerability, requirements for the vulnerability to be expressed, impacts of the vulnerability when expressed, etc.). This information regarding the vulnerability may be obtained in various ways. For example, a requestor (e.g., a user) of the data processing system may request that a security process be performed based on a vulnerability known to the requestor. Information regarding the known vulnerability may then be provided based on the request.

Additionally, information regarding the vulnerability may be obtained by receiving it from another device. For example, and as previously discussed with regard to FIG. 2A, the other device may be operated by a research group that may actively investigate and distribute information regarding vulnerabilities. Accordingly, the information regarding the vulnerability may be generated based on an investigation, and once generated, may be publicly distributed, allowing for the information regarding the vulnerability to be obtained by any data processing system.

Thus, the information regarding the vulnerability, once obtained, may be used to make the identification.

At operation 302, a determination is made regarding whether the data processing system has expressed the vulnerability. The determination may be made by identifying, based on the requirements for the vulnerability to be expressed, an operation of the component. The operation may be identified by parsing the requirements. For example, the requirements may specify the operation.

The determination may further be made by using a record of changes in the operation of components of the data processing system over time. The record may be used to make a second determination regarding whether the component actually performed the operation. For example, the record may list previous operations performed by the component, as discussed with regard to FIG. 2B. If the operation is listed in the record, then it may be determined that the operation has been performed by the component. Additionally, if the operation is not listed in the record, then it may be determined that the operation has not been performed by the component.

Thus, if determined that the operation has been performed by the component, then it may be concluded that the vulnerability of the component has been expressed by the data processing system. If expressed, then the exploitation of the expressed vulnerability may be possible.

Otherwise, if determined that the operation has not been performed by the component, then it may be concluded that the vulnerability of the component has not been expressed by the data processing system. If not expressed, then the exploitation of the expressed vulnerability may not be possible.

If it is determined that the vulnerability is expressed by the data processing system, then the method may proceed to operation 304. Otherwise, the method may proceed to operation 306.

At operation 304, an action set is performed to mitigate a potential impact of the expressed vulnerability. The action set may be performed by obtaining information regarding the operation from the record. For example, the record may be used to identify (i) a time and/or date of when the component began performance of the operation and (ii) a duration of time during which performance of the operation occurred. By doing so, a time frame for when the expression of the vulnerability began to when the expression ended (if not indicated that expression is ongoing) may be obtained. By obtaining the time frame, the potential impact of the expressed vulnerability may be predicted with greater accuracy. For example, the time frame may indicate specific data (e.g., passwords, emails, credit card numbers, social security numbers, bank account numbers, etc.) of the data processing system that is at-risk of compromise due to the possible exploitation of the expressed vulnerability.

The action set may further be performed by making a third determination (e.g., based on the information regarding the operation) regarding whether a malicious entity exploited the expressed vulnerability. To do so, any number of diagnostic processes may be performed. For example, the diagnostic processes may include searching for malware, viruses, artifacts, and/or other indicators of previous (and/or ongoing) presence of the malicious entity.

Based on the third determination, a second action set may be performed to mitigate an impact of the exploitation. For example, and as discussed with regard to FIG. 2A, various services may be performed such as (i) changing passwords, (ii) freezing credit, (iii) searching through databases for compromised information, (iv) monitoring of accounts for suspicious activity, (v) scrubbing compromised information from websites, and/or (vi) other actions that may reduce the impact of compromised information.

Thus, by performing the first action set (and additionally, in some cases, the second action set) the impact of possible exploitation of the vulnerability expressed by the data processing system may be mitigated.

The method may end following operation 304.

Returning to operation 302, the method may proceed to operation 306 if it is determined that the vulnerability is not expressed by the data processing system.

At operation 306, a requestor is confirmed that the data processing system does not express the vulnerability. The requestor may be confirmed by providing a notification to the requestor and/or otherwise communicating information to the data processing system that indicates the data processing system does not express the vulnerability. For example, the notification may specify that the data processing system has not been exploited using the vulnerability due to the exploitation only being possible when the vulnerability is expressed. The method may end following operation 306.

Thus, using the method illustrated in FIG. 3, embodiments disclosed herein may manage security and/or operation of data processing systems by proactively identifying whether vulnerabilities have been expressed by the data processing systems using information regarding conditions of hardware and/or software components of the data processing systems recorded over time. By doing so, resources used for mitigation of an impact of exploitation of the vulnerabilities may be reserved for data processing systems that express the vulnerabilities. By reserving these resources in this way, security and/or operation of data processing systems may be enhanced. Thus, a likelihood of compromise of computer implemented services caused by exploitation of vulnerabilities may be reduced.

Any of the components illustrated and/or discussed in FIGS. 1-2E may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing security of a data processing system, the method comprising:
making an identification of a vulnerability of a component of the data processing system, the vulnerability rendering the data processing system exploitable by a malicious entity if the vulnerability is expressed by the data processing system;
making a determination regarding whether the data processing system expressed the vulnerability, the determination being made using a record of changes in operation of the components of the data processing system over time and requirements for the vulnerability to be expressed;
in a first instance of the determination where the vulnerability is expressed by the data processing system:
performing an action set to mitigate a potential impact of the expressed vulnerability; and
in a second instance of the determination where the vulnerability is not expressed by the data processing system:
confirming to a requestor that the data processing system did not express the vulnerability.

2. The method of claim 1, wherein making the determination comprises:
identifying, based on the requirements for the vulnerability, an operation of the component;
making a second determination, based on the record, whether the component performed the operation;
in a first instance of the second determination where the component performed the operation:
concluding that the vulnerability was expressed by the data processing system; and
in a second instance of the second determination where the component did not perform the operation:
concluding that the vulnerability was not expressed by the data processing system.

3. The method of claim 2, wherein making the determination further comprises:
in the first instance of the second determination:
identifying a duration of time while the vulnerability was expressed by the data processing system using the record.

4. The method of claim 1, further comprising:
monitoring the changes to the operation of the components; and
recording the changes in an immutable record to obtain the record.

5. The method of claim 4, wherein monitoring the changes comprises:
identifying updates made to software components of the components.

6. The method of claim 5, wherein monitoring the changes further comprises:
identifying durations of time during which each updated software component of the software components was hosted by the data processing system.

7. The method of claim 6, wherein each updated software component is a version of the software component.

8. The method of claim 5, wherein the requirements for the vulnerability to be expressed comprise:
a version of the software component to be hosted by the data processing system.

9. The method of claim 1, wherein performing the action set comprises:
making a second determination regarding whether a malicious entity exploited the expressed vulnerability;
in an instance of the second determination in which the malicious entity exploited the expressed vulnerability:
performing a second action set to mitigate an impact of the exploitation of the expressed vulnerability.

10. A non-transitory machine-readable medium having instructions stored therein, which when executed by a processor, cause the processor to perform operations for managing security of a data processing system, the operations comprising:
making an identification of a vulnerability of a component of the data processing system, the vulnerability rendering the data processing system exploitable by a malicious entity if the vulnerability is expressed by the data processing system;
making a determination regarding whether the data processing system expressed the vulnerability, the determination being made using a record of changes in operation of the components of the data processing system over time and requirements for the vulnerability to be expressed;
in a first instance of the determination where the vulnerability is expressed by the data processing system:
performing an action set to mitigate a potential impact of the expressed vulnerability; and
in a second instance of the determination where the vulnerability is not expressed by the data processing system:
confirming to a requestor that the data processing system did not express the vulnerability.

11. The non-transitory machine-readable medium of claim 10, wherein making the determination comprises:
identifying, based on the requirements for the vulnerability, an operation of the component;
making a second determination, based on the record, whether the component performed the operation;
in a first instance of the second determination where the component performed the operation:
concluding that the vulnerability was expressed by the data processing system; and
in a second instance of the second determination where the component did not perform the operation:
concluding that the vulnerability was not expressed by the data processing system.

12. The non-transitory machine-readable medium of claim 11, wherein making the determination further comprises:
in the first instance of the second determination:
identifying a duration of time while the vulnerability was expressed by the data processing system using the record.

13. The non-transitory machine-readable medium of claim 10, wherein the operations further comprise:
monitoring the changes to the operation of the components; and
recording the changes in an immutable record to obtain the record.

14. The non-transitory machine-readable medium of claim 13, wherein monitoring the changes comprises:
identifying updates made to software components of the components.

15. The non-transitory machine-readable medium of claim 14, wherein monitoring the changes further comprises:
identifying durations of time during which each updated software component of the software components was hosted by the data processing system.

16. A data processing system, comprising:
a processor; and
a memory coupled to the processor to store instructions, which when executed by the processor, cause the processor to perform operations for managing security of a data processing system, the operations comprising:
making an identification of a vulnerability of a component of the data processing system, the vulnerability rendering the data processing system exploitable by a malicious entity if the vulnerability is expressed by the data processing system;
making a determination regarding whether the data processing system expressed the vulnerability, the determination being made using a record of changes in operation of the components of the data processing system over time and requirements for the vulnerability to be expressed;
in a first instance of the determination where the vulnerability is expressed by the data processing system:
performing an action set to mitigate a potential impact of the expressed vulnerability; and
in a second instance of the determination where the vulnerability is not expressed by the data processing system:
confirming to a requestor that the data processing system did not express the vulnerability.

17. The data processing system of claim 16, wherein making the determination comprises:
identify, based on the requirements for the vulnerability, an operation of the component;
making a second determination, based on the record, whether the component performed the operation;
in a first instance of the second determination where the component performed the operation:
concluding that the vulnerability was expressed by the data processing system; and
in a second instance of the second determination where the component did not perform the operation:
concluding that the vulnerability was not expressed by the data processing system.

18. The data processing system of claim 17, wherein making the determination further comprises:
in the first instance of the second determination:
identifying a duration of time while the vulnerability was expressed by the data processing system using the record.

19. The data processing system of claim 16, wherein the operations further comprise:
monitoring the changes to the operation of the components; and
recording the changes in an immutable record to obtain the record.

20. The data processing system of claim 19, wherein monitoring the changes comprises:
identifying updates made to software components of the components.
